(19) United States
(12) Patent Application Publication
(10) Pub. No.: US 2026/0238738 A1
(43) Pub. Date: Aug. 13, 2026

(54) COMPUTER IMPLEMENTED METHOD

(71) Applicant: Avos Technology Ltd, Cambridge (GB)

(72) Inventors: Kevin Bernitz, Cambridge (GB); Andy Field, Cambridge (GB); Rhys Roberts, Cambridge (GB)

(73) Assignee: Avos Technology Ltd, Cambridge (GB)

(21) Appl. No.: 19/155,911

(22) PCT Filed: Feb. 12, 2024
(86) PCT No.: PCT/EP2024/053434

§ 371 Date: Aug. 12, 2025

(30) Foreign Application Priority Data
Feb. 13, 2023 (GB) 2302038.1

(51) Int. Cl. H04N 7/14; H04N 7/15

(52) U.S. Cl. CPC H04N 7/147; H04N 7/142; H04N 7/15

(57) ABSTRACT

A computer implemented method of operating a third-party application (114) using a video end-system (100) is provided. The video end-system (100) being for video conferencing and comprising video conferencing hardware (130) and a control interface device (120). The computer-implemented method comprises: providing an application environment (112) for a third-party application (114) to run on. The application environment (112) being configured to: route control signals from the control interface device (120) to the third-party application (114); and route media signals between the third-party application (114) and the video conferencing hardware (130) and/or a content stream of a video conferencing call.

### FIELD OF THE INVENTION

The present invention relates to a computer implemented method of operating a third-party application using a video end-system, a computer implemented method of installing a third-party application, and to a video end-system.

### BACKGROUND

Video conferencing systems typically comprise two or more endpoints, whereby each endpoint is configured to communicate with other endpoints through a data or telephony network or other connections for implementing a two-way or multiway video and/or audio conferencing call.

An endpoint, which may also be referred to as a video end-system, is configured to enable users to communicate with other users over a network by sending data streams including audio, video and other content streams (e.g. data files, text, or screen sharing) from one endpoint to another in a two-party conference call. For a multiway conference call, the data streams may be transmitted to a centralised or distributed conferencing network where they are switched or transcoded allowing multiple participants to communicate and share information.

A video end-system may comprise a single purpose endpoint device whose main function is to support video and/or audio conferencing calls. In addition, a video end-system typically comprises additional video conferencing hardware including: one or more video monitors, video cameras, audio microphones, audio speakers, and a controller for enabling users to make video conferencing calls.

In some examples, a video end-system may be an all-in-one unit wherein the single function end point device and the video conferencing hardware included in a same device, for example a desktop unit or a handheld device. In other examples, the video end-system may comprise an endpoint device which is connected to a large screen, a control interface device, and a camera. This configuration may be suitable, e.g., for a small meeting room. In other examples, video end-systems intended for larger rooms or lecture theatres may include an endpoint device which is connected to multiple screens, one or more control interface devices, and multiple cameras and microphones. It should be noted that in all of these examples, the endpoint device and a control interface device may be a same device.

The software running on the video endpoint devices of a video end-system is traditionally proprietary software which is designed for the single use of video conferencing, i.e., for sharing video and content streams with other endpoints. In some cases, a video end-system may be used to simply display content from a computer such as a laptop to attendees within a local meeting room without establishing a conferencing call.

Owing to the single-purpose nature of such endpoint devices, they cannot be used to perform additional functions which they are not already programmed. If additional functionality is required that is outside the capabilities of a single-purpose endpoint device then an external device such as a computer or laptop may be used to perform the additional functionality. The external device may then share the content produced by the additional functionality as a content stream of a video conferencing call.

Accordingly, the present inventors have identified a desire to leverage the hardware of a conventional video end-system for functions other than that designed by the manufacturer of the video end-system.

Increasingly, video end-systems are being implemented by providing a video conferencing application that runs on top of a standard real-time embedded operating system (as opposed to a proprietary operating system such as VxWorks, RTLinux or Windows CE). Basing the design on a standard, mass-market operating system (such as Android) has advantages including support for a wide variety of hardware and no licensing costs. In addition, standard operating systems (such as Android) support the installation of a large variety of third-party applications. However, such third-party applications are typically configured to run on tablets and smart phones making use of a single display that includes a touch-screen. In contrast, a video end-system may have multiple displays and a separate control interface device which means that the video end-system may not be compatible with most third-party applications.

The present invention has been devised in light of the above considerations.

### SUMMARY OF THE INVENTION

According to a first aspect of the present invention there is provided a computer implemented method of operating a third-party application using a video end-system, the video end-system for performing video conferencing calls; the video end-system comprising video conferencing hardware and a control interface device;
the computer-implemented method comprising:
providing an application environment for the third-party application to run on, the application environment configured to:
route control signals from the control interface device to the third-party application; and
route media signals between the third-party application and the video conferencing hardware and/or a content stream of a video conferencing call.

Advantageously, by providing an application environment for running the third-party application, the third-party application may be used with a video end-system without experiencing issues owing to incompatibilities of the third-party application with the video end-system. This enables users of the video end-system (which may, for example, be a meeting room device) to use the video end-system for additional functionality beyond video conferencing. For example, the video end-system may be used for hosting local and/or in-conference collaboration applications to enhance the meeting experience of users. Additionally, the method of the first aspect may also provide the opportunities for third-party application developers to develop new applications which are specifically tailored for video conferencing meetings using a video end-system.

Importantly, the present method enables the third-party application to be executed as a native application which is hosted locally in the video-end system. This is in contrast to existing methods, which may involve the video end-system having to access a browser for use of a remotely hosted application.

The computer implemented method may additionally comprise installing and, optionally, executing the third-party application in the application environment. Accordingly, the functionality of the video end-system may be expanded by running new applications.

In one or more embodiments, the application environment may include a control signals interface, that is to say programming configured to route control signals from the control interface device to the third-party application.

In one or more embodiments, the application interface may include a media signals interface, that is programming configured to route media signals between the third-party application and the video conferencing hardware and/or a content stream of a video conferencing call.

In the present invention the video end-system is intended to refer to a dedicated video conferencing system which comprises function specific (i.e., dedicated) hardware and/or software for performing video conferencing calls.

The video end-system may comprise system software which is configured to operate the video end-system and enable the performance of a conference call using the video end-system. Therefore, the computer implemented method may comprise operating the video end-system to conduct a video and/or audio conferencing call using system software. The system software may be an application or a computer program which includes proprietary software which is provided with and configured to operate with the video end-system.

The video end-system may be managed by a standard operating system. For example, the standard operating system may be a mass-market operating system such as Android. The operating system may be configured to support a collection of mass-market applications produced by third-parties designed to run on mass-market hardware such as tablets or smart phones. Other examples of standard operating systems may include Huawei's HarmonyOS or Apple's iOS

The video end-system may be configured to run a single operating system. The use of the application environment can therefore enable the single operating system to operate system software for video conferencing and the third-party application. Accordingly, both functions may be operated on a same device (e.g., a video endpoint as discussed below) without requiring an additional computing unit to be introduced for operating the third-party application.

The third-party application may be an application, computer program, or software package which provides additional functionality. Specifically, the third-party application may have a function which is a function other than supporting a video conferencing call. For example, the third-party application may include a collaborative application. For example, the application may be one or more of a document sharing, whiteboarding, multimedia presentation, training, reviewing, polling or question submission application. The application may be configured to operate locally or remotely via the internet to include other parties in a video call. The third-party application may be provided by or downloaded from an external source (i.e. the third-party application is not the part of system software which was originally provided with the video end-system for enabling conferencing calls).

The third-party application may be configured to run on mass-market hardware such as tablets or smart phones (i.e. the third-party application may be configured to be compatible with hardware other than the video end-system).

The application environment is intended to refer to a framework or platform which has been configured to accept the deployment of a single application or more than one application. The application environment comprises a predefined collection of computing resources that host an application. The application environment may be configured to provide the third-party application with virtualised or normalised device interfaces for enabling the third-party application to run even if physical devices (originally intended for use with the application) are disconnected or are different from what the application expects. For example, the virtualised device interfaces may be configured to re-route data to different physical devices whilst the application is running.

In some examples, one or more (e.g., multiple) application environments may be provided to operate multiple (respective) third-party applications.

The control interface device, which may also be referred to as a controller, may be any device comprising user input controls or a user interface for enabling users to control the video end-system and/or the third party application hosted in the application environment. For example, the control interface device may be a tablet comprising a touch screen. A user may issue control signals to the video end-system by pressing buttons on the touch screen. For example, user may use the touch screen to begin and end conferencing calls, add or remove parties from a conference call, adjust volume levels of speakers in the video end-system, configured display screen settings, etc. Other examples of control interface device may include a keyboard, a mouse, a control panel with mechanical buttons, a voice control device etc.

Multiple control interface devices may be provided which are connected to (e.g. via wired or wireless connection) the remainder of the video end-system. For example, a control interface device may be a personal device such as a smartphone or computer. Accordingly, the computer-implemented method may further comprise connecting a personal device to the video end-system, and routing the control signals between the personal device and the third-party application. The connection between personal device and the video end-system may be a wireless or wired connection such as a connection over Wi-Fi, or Bluetooth™. The computer-implemented method may further comprises ending a connection between the personal device and the video end-system. In this way, a personal device may be temporarily paired with the video end-system for controlling the third-party application via the device. Accordingly, each user of the video end-system may control the natively installed third-party application from their own device.

The video conferencing hardware may comprise a loudspeaker and a microphone, wherein the media signals include an audio stream. Specifically, the video conferencing hardware may comprise one or more loudspeakers (e.g. as broadcasting speakers or as personal headphones) for producing audio content of a conferencing call and/or audio content from the third-party application received via the application environment. The video conferencing hardware may comprise one or more microphones from providing an audio stream for the content stream of the conferencing call and/or to the third-party application via application environment.

The video conferencing hardware may comprise a camera and/or a display screen for sharing images in a video conferencing call, wherein the media signals include a video stream. Specifically, a video stream may be communicated from the camera to the content stream of the conferencing call and/or to the third-party application via the application environment. One or more additional video streams may be received from the content stream of the conferencing call and/or the third-party application via the application environment to the display screen. Of course, the video end-system may comprise multiple cameras and display screens.

Each component of the video conferencing hardware (i.e., cameras, display screens, microphones, loudspeakers etc) may be provided as one or more integral units or as separate devices. The video conferencing hardware and the control interface device may also be provided as one or more integral units or as separate devices. For example, a controller having a touch screen may serve as a display screen as well as a user input device.

The application environment may be provided on the video end-system. However, in other examples, the video end-system may be in communication with a cloud service (or a separate server on a local network) and the application environment may be provided on the cloud service (or the separate server).

Advantageously, hosting the application environment on a cloud service can improve the performance of the video end-system because the potentially resource-intensive third-party environment need not be hosted and run on the local hardware of the video end-system. In addition, if provided by a cloud service, the application may be completely isolated from a corporate network in which the video end-system is located. This enables untrusted applications to be run without risk to the corporate network.

The video end-system may comprise a processing element for running the system software and operating the video end-system. The application environment may be provided on the processing element of the video end-system or connected to the processing element (e.g. via an internet connection to a cloud service).

For example, the video end-system may comprise an endpoint device which is configured to communicate with the video conferencing hardware and the control interface device. The endpoint device may be configured to perform the computer implemented method of the first aspect.

The endpoint device may be a single-purpose computing device comprising a processor, such as a computer or a local server, which is connected (e.g. by wired or wireless connection) to the video conferencing hardware and the control-interface device. The endpoint device may comprise a network interface for sending and receiving the content stream of a video conferencing call.

In this example, the endpoint device may comprise system software for operating the video end-system and enabling the performance of a conference call. The application environment may be provided natively on the endpoint device within the application environment. Here, the computer-implemented method of the first aspect may be performed by the endpoint device.

In some examples, the application environment may be provided on the (or one of the) control interface device(s). Here, the control interface device may be configured to perform the computer-implemented method of the first aspect. In this example, the control interface device may also be considered as an endpoint device for operating the video end-system to enable conference calls. In other words, the control interface device and the endpoint device may be provided as a single unit. In this example, the single unit may comprise system software for operating the video end-system and enabling the performance of a conference call.

This example is useful for scenarios where one participant of the video call wishes to download and run a third-party application without allocating other resources of the video end-system to running the third-party application. This example may also be advantageous if the video end-system is running an OS which is incompatible with the third-party application, but the control interface is running a different OS which may be compatible with the third-party application.

As mentioned above, the control interface device and the video conferencing hardware may also be provided as a single unit. In this example, the video end-system may be a single desktop or handheld unit which may also be referred to as a video end device.

In some examples, when the application environment is provided on the control interface device, the video end-system may include one or more additional control interface devices. The application environment may be configured to route the control signals from the one or more additional control interface devices to the third-party application. Accordingly, even when the third-party application is installed on a control interface device, it may still be controlled from other devices. The application environment may be configured to route the media signals to the one or more additional control interface devices.

In yet further examples, as mentioned above, the control interface device and video conferencing hardware may comprise separable units which are in communication with each other (e.g. via a wired or wireless connection). Accordingly, the control signals may be routed between the endpoint device and the control interface device via the wired or wireless connection. In this way, users may access and control the natively hosted third-party application from a separate device, such as their own personal device.

When the application environment is provided on the cloud service, the control signals may be routed between the control interface device and the third-party application hosted on the cloud. In these examples, the video end-system may comprise an endpoint device which is in communication with the application environment provided on the cloud service. The control interface device may be connected (wired or wirelessly) to the endpoint device. Accordingly the control signals may be routed between the control interface device and the third-party application hosted on the cloud via the endpoint device. In this way, a permanent or temporary connection may be formed between the control interface deice and the endpoint device which may already be connected to the application environment provided on the cloud service. In this way, users may use any suitable control interface device to launch and control the application, even when it is hosted on the cloud.

The control interface device and the endpoint device may be in communication via a cloud-based relay service. Therefore, in this example, the application environment may be located on an endpoint device and the application environment may receive the control signals from the control interface device via the cloud-based relay service. Here, the endpoint device may, itself, be a first control interface device and a second control interface device may be in communication with the first control interface device via the cloud based relay service.

An advantage of the endpoint device and the control interface device communicating via the cloud may be that a wireless network to which the controller is connected may be different to and firewalled from a network to which the video end-system is connected to. Therefore, there may be no direct communication between the two devices. Accordingly, by communicating via the cloud, the endpoint device and the control interface device may be able to communicate even if they are connected to separate networks.

The application environment may comprise a data mapping interface which is configured to relay control signals from the control interface device to the third-party application; and relay media signals between the third-party application and the video conferencing hardware and/or a content stream of a video conferencing call. The data mapping may be a virtual interface which defines a boundary to the application environment and act as a virtualisation layer by relaying data between the third-party application inside the application environment and software and hardware which is external to the application environment.

The media signals may include video data, and/or audio data (e.g. an audiovisual signal operating in a mode with a camera turned “off”) which forms the content stream of a video conferencing call. In some examples the media signals may include other types of data which may pass to and from the third-party application. For example, the media signals may include computer files, or text (e.g. other types of audiovisual related data, for example stills, computer files, text that can be shared over a video link). The control signals may comprise signals for selectively enabling and disabling the routing of the media signals between the third-party application and the video conferencing hardware and/or the content stream of the video conferencing call.

For example, the media signals may comprise video from the third-party application for enabling remote-view of the third-party application via the video conferencing hardware and/or the content stream of the video conferencing call. Therefore, the computer implemented method may comprise receiving remote view control signals from the control interface device, and enabling or disabling remote view of the third-party application on one or more video conferencing hardware units and/or enabling or disabling remote view of the third-party application for one or more channels of a video conferencing call based on the remote view control signals. In this way, a user of the video end-system may decide which display screens to display the third-party application on and which remote participants of the video conferencing call can view the third-party application.

The application environment may be configured to transform the control signals from the control interface device having a first format to application control signals for controlling the third-party application having a second format (i.e. using a data mapping interface). In other words, the computer implemented method may comprise: using the data mapping interface to transform (i.e., reformat) the control signals from the control interface device having a first format to application control signals for controlling the third-party application having a second format. For example, the application environment may be configured to emulate gestures or key-presses in the application upon receipt of user control signals from the control interface. This may include emulating function buttons, a virtual keyboard, a dial pad, a directory lookup, or other navigation elements for the third-party application in the application environment. In some examples, this functionality may be used to the control signals from a control interface device, which is separable from the endpoint device, to the third-party application which is hosted on the endpoint device.

In this way, a replacement user interface (UI) may be provided for operating the third-party application in the application environment which maps UI signals from a first system (e.g., on a control interface device) which may operate a first OS to a second, different system (i.e., in the application environment of the endpoint device) which may operate a second, different OS. In some examples, a custom replacement UI may be provided for a particular third-party application to be used in the new environment. The custom replacement UI may be provided by a custom configuration service as discussed below.

For example, the control interface device (or one or the control interface devices) may comprise a keyboard for sending control signals which are keyboard events. The application environment may be configured to transform the keyboard events into application control signals for controlling the third-party application. In other words, the computer implemented method may comprise: transforming the control signals comprising keyboard events from the control interface device having a first format to application control signals for controlling the third-party application having a second format. The application control signals may be configured to mimic control signals expected by the third-party application. For example, the key board events may be transformed into function signals corresponding to function buttons normally provided by the third-party application.

The control interface device may comprise a touch screen having a first size for sending control signals, and the third-party application may be configured to receive application control signals from a touch screen having a second size. For example, the application may be intended to be run on a smart phone and the control interface device may be a much larger screen. In this case, the application environment may be configured to scale or map the control signals from the control interface device to the application control signals for controlling the third-party application. In other words, the computer implemented method may comprise: scaling the control signals from the control interface device to form application control signals for controlling the third-party application. For example, the application environment may be configured receive position and movement information from the control interface device touchscreen and scale the position and movement information proportionally to correspond to the application touchscreen.

The control interface device may comprise a user interface environment for running an application user interface associated with the third-party application. For example, the control interface device may comprise a screen or a touch screen and the application user interface may be configured to display a representation of the third-party application on the screen. The representation of the third-party application may include function buttons, a virtual keyboard, a dial pad, a directory lookup, or other navigation elements for navigating and/or controlling the third-party application.

Similarly, the application environment may be configured to transform video signals from the third-party application having a first format to media signals for the content stream of the video conferencing call and/or the video conferencing hardware having a second format. In other words, the computer implemented method may comprise: transforming media signals from the third-party application having a first format to media signals for the content stream of the video conferencing call and/or the video conferencing hardware having a second format. For example, the media signals may include video signals and the application environment may be configured reformat video data to map screen sizes, video formats (e.g. compressed vs uncompressed), numbers of pixels etc between formats compatible with the application and the video conferencing hardware and/or the content stream of the video conferencing call. In other examples, the media signals may include audio signals, images, or file data etc which are transformed from a first format compatible with the third-party application to a second format.

The application environment may comprise a data mapping interface which is formed from an application programming interface (API) provided by the third-party application.

In some examples, the application environment may comprise customised instructions corresponding to the third-party application. For example, the application environment may be configured to implement a custom replacement UI for a particular third-party application which is configured to map control and/or media signals between the third-party application and the control interface device. Therefore, a control interface device having a different operating system and/or UI format to the endpoint device or the third-party application may be able to control and/or view the third-party application.

The customised instructions may be stored in a centralised configuration service. The centralised configuration service may be located on a remote server which is accessible by the video end-system. In this case, the computer implemented method may comprise retrieving the customised instructions from the centralised configuration service and implementing or creating the data mapping interface based on the customised instructions. For example, the centralised configuration service may comprise a curated app store of customised UI instructions and respective third-party applications for installing on the video end-system.

The video end-system may be in communication with a centralised monitoring service, and the computer-implemented method may comprise: monitoring the third-party application from the centralised monitoring service. The centralised monitoring service may be located on a remote server. The centralised monitoring service may be the same service as the centralised configuration service. For example, the centralised monitoring service may be configured to monitor is the third-party applications is an authorised application which is allowed to be installed on the video-end system. In further examples, the centralised monitoring service may be configured to choose which apps from the curated store may be installed on a particular video end-system, what control interface devices may be used with each app and/or each video end-system, what control permissions for the third-party app may be enabled.

Additionally, the third-party application itself may be monitored to ascertain and/or log how it works and/or how well the third-party application operates. For example, error reports may be issued to the centralised configuration service related to a particualer third-party application. The third-party configuration service may be configured to issue updated customised instructions for interfacing to the third-party application. The video end-system may comprise a management interface for enabling administrators to enable or disable authorisation for the download of third-party applications. For example, if a user wishes to install as new third-party application the computer implemented method may comprise first requesting authorisation from a user to download the new third-party application. The authorisation may then be received as a password inputted via the control interface device.

In some examples, the enabling or disabling of authorisation for the download of third-party applications on the video end-system may be performed by the centralised configuration service.

The video end-system may be configured to communicate with a management server or cloud service (e.g., the centralised configuration service discussed above) to retrieve a list of authorised applications.

The video end-system may then download the third-party application only if the third-party application is included in the list. In some examples, a user may be presented with the list of authorised applications from which an application may be chosen for installation for operation by the video end-system.

The application environment containing the third-party application may be sandboxed whereby access by the third-party application to computer resources is restricted. For example, the third-party application may be restricted from full access to CPU, Memory, File-system, Network, audio or display resources. In this way, potential malicious activities of an untrusted third-party application may be reduced.

Sandboxing may be performed by hosting the third-party application on a Guest Virtual LAN or by hosting the application environment on a cloud server to further isolate the third-party application from a corporate network or the remainder of the video end-system.

In other examples, the third-party application may be a trusted application and may be provided with direct access to computing resources such as CPU, Memory, File-system, network, audio or display resources. This is useful for increasing the efficiency and performance of trusted third-party applications by removing delays which may be introduced by virtualisation layers.

In a second aspect of the present invention there may be provided: a computer implemented method of installing a third-party application for use by a video end-system, the video end system for video conferencing, the method comprising:
creating an application environment;
the application environment configured to:
   relay control signals from a control interface device to the third-party application, and
   relay media signals between the third-party application and the video conferencing hardware and/or a content stream of a video conferencing call; and
installing the third-party application inside the application environment.

In some examples, installing a third-party application for use by a video end-system may include installing the third-party application on the video end-system. In other examples, installing a third-party application for use by a video end-system may include installing the third-party application on a cloud server which is in communication with the video end-system.

The computer implemented method of the second aspect may further comprise: downloading customised instructions corresponding to the third-party application from a centralised configuration service for forming the application environment.

In some examples the computer implemented method may further comprise communicating with a management server or cloud service to retrieve a list of authorised applications, and downloading the third-party application, only if the third-party application is included in the list. Therefore, instances of potentially malicious third-party applications may be reduced. In addition, owners of the video end-system may control whether potentially resource intensive third-party applications may be downloaded to the video end-system.

The computer implemented method may include receiving user authentication information to enable the installation of the third-party application. Therefore, the video end-system has improved security and may be protected from the download of potentially malicious third-party applications by unauthorised users.

For the avoidance of doubt it should be noted that the computer implemented method of the second aspect and the optional features thereof may form additional steps of the computer implemented method of the first aspect.

In a further aspect of the present invention there may be provided a computer program comprising instructions which, when the computer program is executed by a computer, cause the computer to carry out the method of any one of the previous aspects. The computer program product may take the form of a non-tangible computer program product comprising said instructions.

Further aspects of the invention may provide a computer-readable storage medium, having stored thereon the computer program of the previous aspect of the invention.

In another aspect of the present invention there may be provided an application environment configured to host a third-party application for operation by a video end-system, wherein the application environment is configured to:
route control signals from a control interface device of the video end-system to the third-party application; and
route media signals between the third-party application and video conferencing hardware and/or a content stream of a video conferencing call.

In some examples, the application environment may be configured to run on the video end-system. In other examples, the application environment may be configured to run on a cloud service in communication with a video end-system.

In another aspect of the present invention there may be provided a video endpoint system for video conferencing comprising: video conferencing hardware and a control interface device; wherein the video conferencing hardware optionally comprises a screen, a camera and a loudspeaker, and the video end-system is configured to carry out the method of any one of the first or second aspects.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a diagram of a video conferencing system comprising two video end-systems according to the prior art;

FIG. 2 shows a diagram of a video end-system according to an embodiment of the present invention;

FIG. 3 shows a diagram of the video end-system of FIG. 2;

FIG. 4 shows a diagram of a video end-system according to another embodiment of the present invention;

FIG. 5 shows a diagram of a video end-system according to another embodiment of the present invention;

FIG. 6 shows a diagram of a video end-system according to another embodiment of the present invention;

FIG. 7 shows a diagram of a video end-system according to another embodiment of the present invention;

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

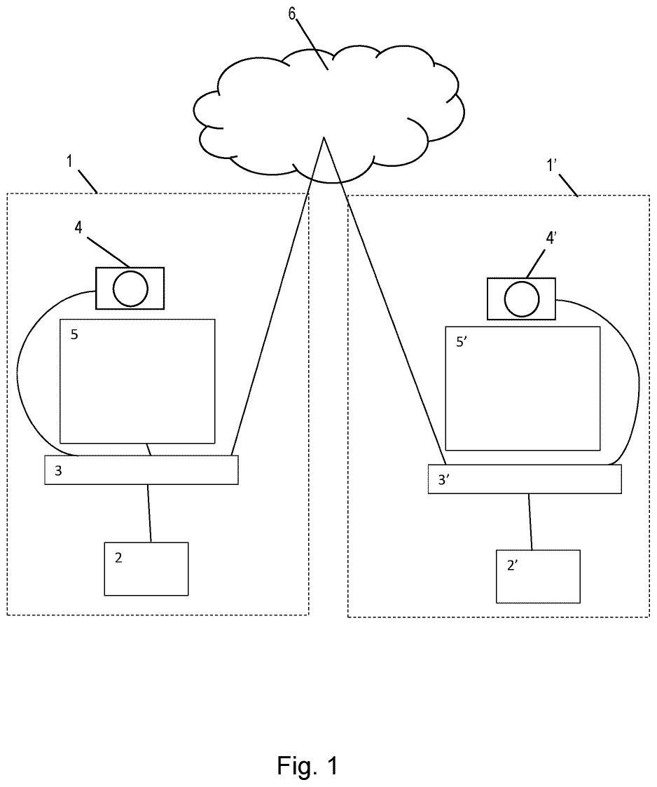

FIG. 1 shows a diagram of a typical video conferencing system comprising a video end-system 1 connected to a second video end-system 1′ according to the prior art.

Each video end-system 1, 1′ comprises an endpoint device 3, 3′ connected to a control interface device 2, 2′ and to video conferencing hardware comprising a display screen 5, 5′, and a camera 4, 4′.

In this example, the first and second video end-systems 1, 1′ are connected to each other via the internet 6 for enabling two-way communication. In this way, video footage from the camera 4 or other media content (e.g. audio, computer files, text) from the first end-system 1 may be received by the second video end-system 1′ and displayed on the screen 5′. Likewise, content from the second video end-system 1′ may be received by the first video end-system 1.

The endpoint device 3 may be a local processing resource comprising proprietary software running on a mass-market operating system such as Android. The endpoint device 3 is configured to control the video end-system 1 and enable the video end-system to perform video conferencing calls. In some examples, the video end-system 1 may comprise multiple local processing resources which are spread across multiple devices. In some examples, the video end-system 1 may be connected to a remote processing

The control interface device 2 comprises a user interface and may optionally be a separate device or built into a same unit as the endpoint device 3. For example, the entire video end-system may be a personal device (e.g. comprising a touch screen) or, in the case of a conference room system, the control interface device 2 may be one of several control interface devices (e.g. touch-screens) located around a conference room table. When the control interface device 2 is a separate unit, the control interface device 2 may run a mass-market operating system such as Android. Other examples of control interface device 2 may include a keyboard, a mouse, function buttons, or other user controls.

The control interface device 2 is configured to receive user inputs and relay them as control signals to the endpoint device for controlling the hardware and running conference calls.

In this example, the control interface device 2, the camera 4 and the display screen 5 are connected to the endpoint device 3 via wired or wireless data connections. For example, the data connections may be wired connection including USB or Powered Ethernet, such as 802.3at, or wireless connections including Wi-Fi or Bluetooth. The data connections between each device in the video end-system 1 may be direct point-to-point connections or indirect connections which include data relays via a server or servers on the internet 6.

A user wishing to run a third-party application on a video end-system according to the prior art may be unable to do so owning to incompatibilities between the video end-system and the third-party application in question. Accordingly, the present inventors have devised a method operating a third-party application using a video end-system which is configured for video conferencing.

In the examples that follow, alike features have been given corresponding reference numerals, and corresponding descriptions may apply except where such a description is clearly impermissible or expressly avoided.

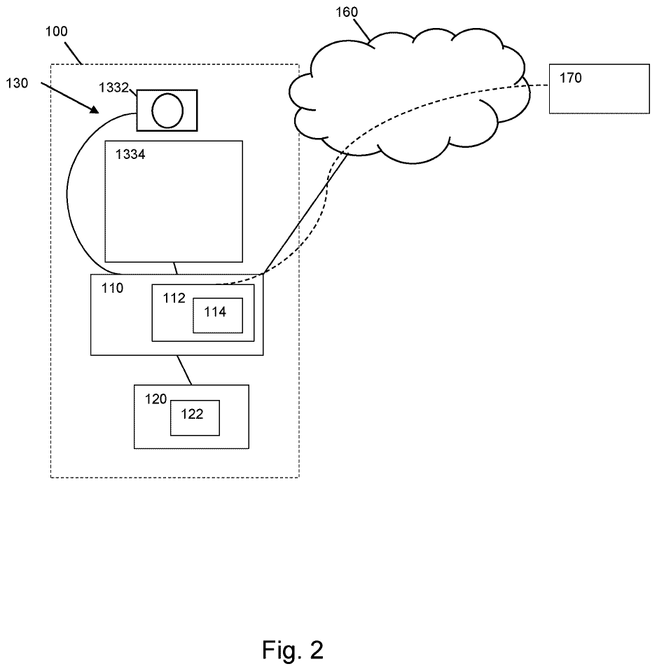

FIG. 2 shows a diagram of a video end-system 100 according to an embodiment of the present invention.

In this example, the video end-system 100 comprises a video endpoint device 110 connected video conferencing hardware 130 and a control interface device 120. The endpoint device 110 is connected to the internet 160 for exchanging a content stream of a video conferencing call with remote parties.

The endpoint device 110 is configured to send and receive media signals from the video conferencing hardware which may form part of the content stream of the video conferencing call. For example, in FIG. 2 the video conferencing hardware includes a camera 1332 and a display screen 1334 for recording and displaying video footage.

The endpoint device 110 is also configured to receive control signals from the control interface device 120 for controlling the video end-system 100.

In this example, the endpoint device 110 is configured to run a third-party application 114 which is hosted inside an application environment 112 provided on the endpoint device 110.

In this example, an additional user interface environment 122 is provided on the control interface device 120 for hosting an application user interface of the third-party application. For example, if the control interface device 120 comprises a touchscreen, then a video feed from the third-party application 114 may be provided to an application user interface running in the user interface environment 122 so that a remote view of the third-party application 114 can be displayed on the touchscreen.

Additionally, the application environment 112 on the endpoint device 110 is connected to a management agent service 170 via the internet 160. The management agent service 170 contains information regarding the identities and permitted behaviour of each video end-system 100 under its control.

Examples of permitted behaviour may include a list of authorized third-party applications that may be run on the video end-system 100, details regarding the manner in which each application 114 may be run such as whether user authorisation from a user is required, whether the application 114 may be shared with any or specific remote parties, and/or whether the application 114 must be restricted in terms of device or network access. The management agent service 170 is configured to send configuration management controls to the application environment 112.

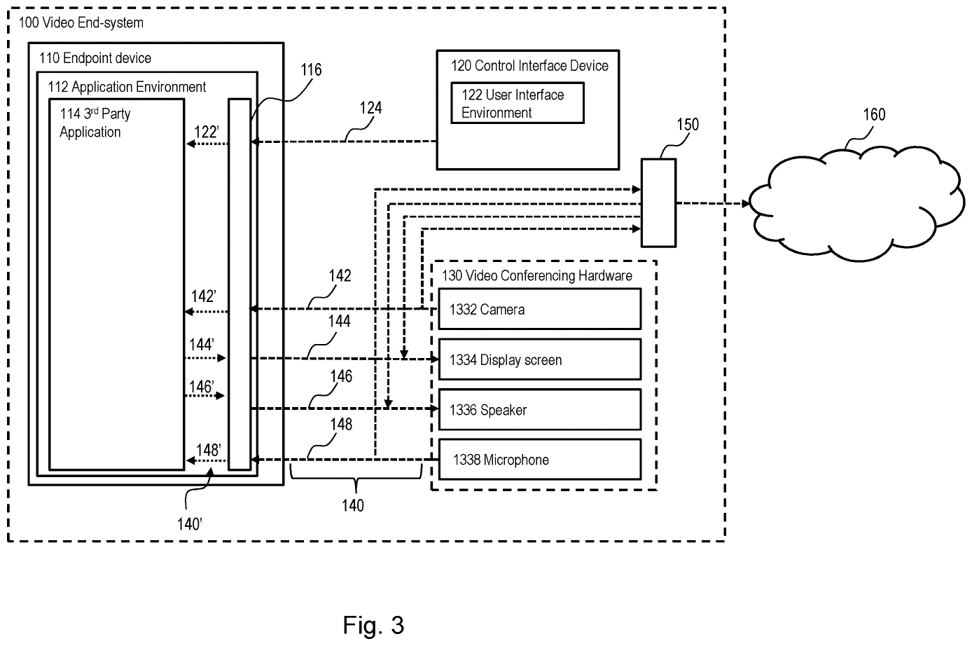

FIG. 3 shows another diagram of the video end-system 100 of FIG. 2. In FIG. 3 the video conferencing hardware 130 additionally includes a speaker 1336 and a microphone 1338 for playing and recording audio data for the content stream of a video call. Additionally, the video end-system 100 comprises a network interface 150 for connecting to the internet 160.

As shown in FIG. 3, the application environment 112 comprises an environment interface 116 for relaying signals between the third-party application 112 and other components of the video end-system 100.

The environment interface 116 (which may also be referred to as a data mapping interface 116) is configured to route control signals 124 from the control interface device 120 to the third-party application 114. The environment interface 116 is also configured to route media signals 140 between the third-party application 112 and the video conferencing hardware 130 and/or the content stream of a video conferencing call via the network interface 150. In some examples, the application environment 112 may be configured to relay other types of data between the third-party application 114 and the remainder of the video end-system such as data files, text, etc.

In the example shown, the media signals 140 includes a video stream 142 received from a camera which is relayed to the third-party application 112 via the data mapping interface 116 and to the network interface 150 to form part of the content stream of a video call. In addition, a video stream 144 received from the third-party application 112 via the data mapping interface 116 (or from the network interface 150) as part of the content stream of a video call is relayed to a display screen 1134. Likewise an audio stream 148 received from a microphone 1338 is relayed to the third-party application 112 via the data mapping interface 116 to the network interface 150 to form part of the content stream of a video call, and an audio steam 146 received from the third-party application 112 (or from the network interface 150) is provided to a speaker 1336.

In use, a user may request installation of the third-party application 112 (e.g. an Android application) on the video end-system 100 via the user interface of the control interface device 120. The control interface device 120 then contacts the intended application hosting device (i.e. the endpoint device 110 in this example) and instructs the hosting device to create an application environment 112 for the third-party application 114 to run on and then downloads the third-party application 114 into the application environment 112.

The third-party application 114 may have pre-requisite requirements for running on a typical device. Creating the application environment 112 includes allocating CPU and memory resources as well as virtual devices and/or interfaces such as a display, keyboard and touch-screen for the application 114. When the third-party application 114 is launched into the created application environment 112, the prerequisite requirements of the third-party application 114 are provided such that the application environment 112 emulates a typical device such as a conventional mass-market tablet or phone from the point of view of the third-party application 114.

The user interface of the video end-system 100 located on the control interface device 120 may then be used to connect to the third-party application 112 in a variety of ways described herein.

In one example, a virtual video stream may be relayed across the connection between the endpoint device 110 and the control interface device 120 such that an application video output of the third-party application 114 may be displayed on the control interface device 120. The video view may be displayed full-screen if the aspect ratio and resolution of a screen provided on the control interface device 120 is similar to the requirements of the third-party application 120. In other examples, the user interface environment 122 on the control interface device 120 may be configured to display the application video output in a window on a screen of the control interface device 120. In some examples, a user of the control interface device 120 may make use of zoom gestures such as two-finger pinch to zoom the video. This example is useful for setting up a third-party application 114, e.g. by entering user credentials, where the information should not be shared with the other attendees in a meeting room.

In another example, a video output from the third-party application 114 may be connected to or redirected to the display screen 1334 or to the content stream of a video conferencing call. If the display screen 1334 includes a touch-screen, the touch-screen gestures may be relayed back to the third-party application 114.

In some examples, when the endpoint device 110 includes a graphics processing unit (GPU), and/or a screen, and/or a touch screen on a same unit, the third-party application 112 hosted on the endpoint device 110 may be given direct access to the GPU, the display and/or the touch-screen (i.e., without a virtualisation layer). This can be useful for improving the efficiency and performance of the third-party application 114.

The data mapping interface 116 may be configured to transform control signals 124 from the control interface device 120 having a first format to application control signals 124′ for controlling the third-party application 112 having a second format.

For example, the control interface device 120 may include a physical touch-pad or a virtual touch-pad emulated by a touch-screen of the control interface device 120. Touch gestures from the touch-pad of the virtual touch-pad may be relayed over the connection between the control interface device 120 and the endpoint device 110 to the third-party application 112 via the data mapping interface 116 as touch gestures. In this example, the application environment 112 may be configured to correctly map the gesture positions between the touchpad or virtual touchpad of the control interface device 120 and a target virtual display of the third-party application 112 which has a different size, taking into account any active crop, zoom, screen size differences and aspect ratios between the touch screen of the control interface device 120 and the target virtual display of the third-party application 112.

In another example, the endpoint device 110 or the control interface device 120 may be programmed with customised instructions associated with a specific third-party application 112 for forming the application environment and/or the user interface environment 122. The customised instructions may be configured to provide an enhanced user interface on the control interface device 120 to replace a conventional user interface of that third-party application 112. In this way a user interface that is more appropriate for the hardware of the video end-system 100 may be provided, in place of the user interface of the third-party application which may be better suited to different hardware (e.g. a smart phone).

For example, the enhanced user interface provided on the control interface device 120 may include application specific function buttons, a virtual keyboard, a dial pad, a directory lookup, or navigation elements which are configured for controlling the third-party application 114. The application environment 112 may be configured to convert control signals 124 from the enhanced user interface into control signals 124′ which emulate gestures and key-presses expected by the third-party application 114.

The customised instructions for a particular third-party application 112 may be provided by a central server, (e.g., on the internet 160) which may be downloaded by the endpoint device 110 and/or the control interface device 120. The customised instructions may include a combination of structured data, code, and/or portable code. In some examples, the customized instructions may comprise an application programming interface (API) provided by the third-party application 114.

In some examples, a list of authorised third-party applications that are permitted to be operated by the video end-system 111 may be centrally managed by a management server or cloud service. The video end-system 100 may connect to the management server or cloud service to retrieve the list of authorised applications. If a desired third-party application is included in the list of authorised applications, then the endpoint device 110 may download the third-party application 114 from a publicly accessible repository (for example from the Google Play Store) or a from private repository such as a private server or from the management server itself or from the cloud service. This is useful for reducing the likelihood of malicious third-party applications 112 being installed on the video end-system 100.

Additionally or alternatively, a management interface may be provided (e.g. on the control interface device 120) to enable administrators to enable or disable authorisation for specific third-party applications 114. In some examples, a user login or video end-system device identifier may be required to enable or disable the download of a third-party application 114.

In another embodiment, the management server or the management interface may be configured to permit guest applications that are not included in the list of authorized applications to be operated by the video end-system 100. This may be permitted based on a user login or based on a video end-system device identifier.

In further examples, the management server or cloud service may be configured monitor the usage and behaviour of the third-party applications 114.

In some examples, the endpoint device 110 may be configured to sandbox the third-party application 112 whereby access by the third-party application 112 to computer resources of the video end-system 100 is restricted. For example, the third-party application 112 may be restricted from full access to CPU, Memory, File-system, Network, audio or display resources. The access of the third-party application 112 to network resources may be restricted by hosting the third-party application 112 on a Guest Virtual LAN so that network traffic related to the sandboxed third-party application may be separated from other network traffic.

In another example, the aforementioned sandboxing may take place on a cloud server to further isolate the third-party application 112 from the corporate network. In this example, the third-party application 112 may only have access to selected media and control signals of the video end-system 100.

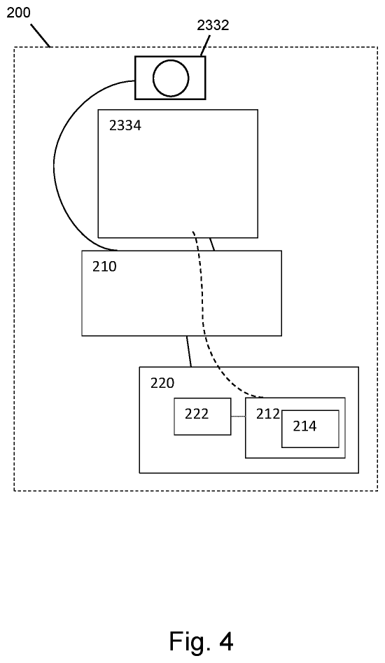

FIG. 4 shows a diagram of a video end-system 200 according to another embodiment of the present invention. In this example, the application environment 212 containing the third-party application 214 is provided on the control interface device 220 which also hosts the environment user interface 222. A remote view (i.e. a video stream) of the third-party application 214 is routed by the application environment 212 to the display screen 2334 via the endpoint device 210.

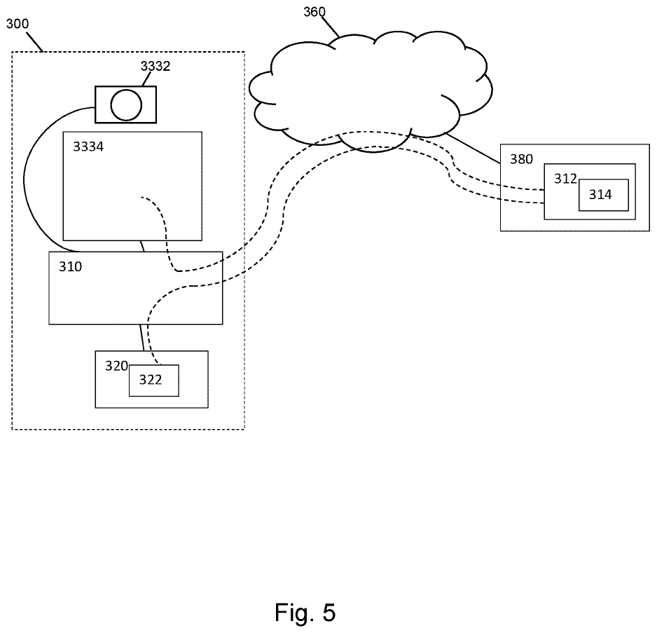

FIG. 5 shows a diagram of a video end-system 300 according to another embodiment of the present invention. In this example, the application environment 314 containing the third-party application 312 is provided on a cloud service 380.

An application user interface 322 running on the control interface device 320 is connected via the endpoint device 310 to the application environment 312 on the cloud service 380 via the internet 360 for controlling the third-party application 312. A video stream from the third-party application 314 in the application environment 312 is routed from the cloud service 380 via the internet 360 to the video endpoint device 310 and on to the display screen 3334. If the application user interface 322 requires a video feed from the third-party application 314 then the video stream may also be routed via the same connections to the control interface device 322 for enabling the application 312 to be viewed (e.g. as part of a user interface) on the control interface device 322.

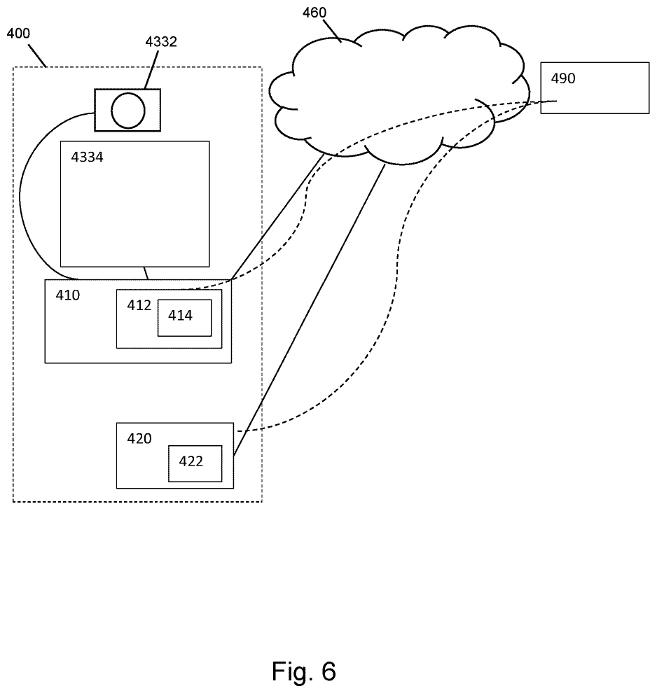

FIG. 6 shows a diagram of a video end-system 400 according to another embodiment of the present invention in which the control interface device 420 is not directly connected to the endpoint device 410 by a wired or a wireless link but is instead connected to the endpoint device 410 indirectly via the internet 460 using a control relay service 490. Control signals from the application user interface 422 running on the control interface device 320 may be routed to via the control relay service 490 to the application environment 412. If the application user interface 422 requires a video feed from the application environment 412 then the video feed may be routed back across the same connections for enabling the third-party application 412 to be viewed (e.g. as part of a user interface) on the control interface device 422.

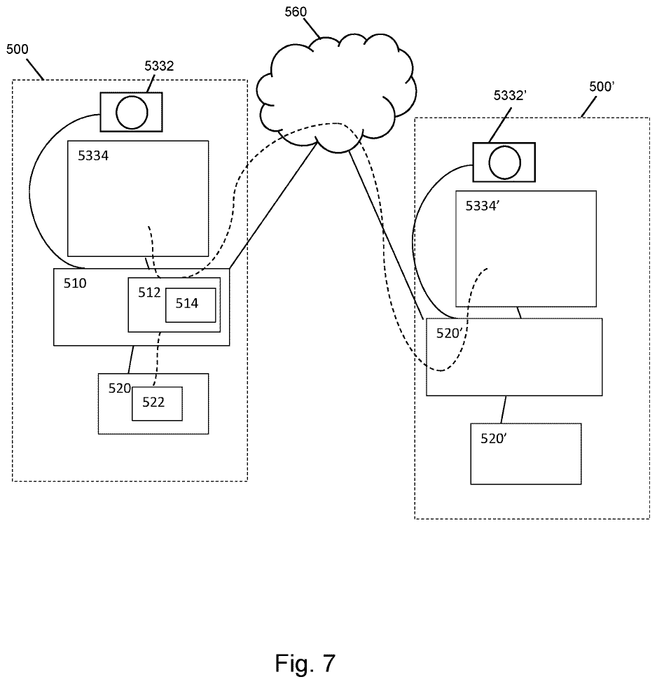

FIG. 7 shows a diagram of a video end-system 500 according to an embodiment of the present invention wherein the video end-system 500 is participating in a conference call with a remote video end-system 500′. In this example, a video output from the third-party application 514 is provided by the application environment 512 as a content stream for the video call enabling the video output of the third-party application 514 to be sent both to the local display 5334 and to a remote video end-system 500′ to be displayed on a remote display screen 5334′.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A computer implemented method of operating a third-party application using a video end-system, the video end-system for performing video conferencing calls; the video end-system comprising video conferencing hardware and a control interface device;
the computer-implemented method comprising:
providing an application environment for the third-party application to run on, the application environment being configured to:
route control signals from the control interface device to the third-party application; and
route media signals between the third-party application and the video conferencing hardware and/or a content stream of a video conferencing call.

2. The computer implemented method according to claim 1, wherein the video conferencing hardware comprises a camera and a display screen, and the media signals include a video stream.

3. The computer implemented method according to claims 1 or 2, wherein the video conferencing hardware comprises a loudspeaker and a microphone, and the media signals include an audio stream.

4. The computer implemented method according to any preceding claim, wherein the application environment is provided on the video end-system.

5. The computer implemented method according to claim 4, wherein the application environment is provided on the control interface device.

6. The computer implemented method according to claim 4, wherein the video end-system comprises a video endpoint device in communication with the control interface device and the video conferencing hardware, wherein the application environment is provided on the video endpoint device.

7. The computer implemented method according to claim 6, wherein the control interface device and the video endpoint device are in communication via a cloud-based relay service, and the application environment is configured to receive the control signals from the cloud-based relay service.

8. The computer implemented method according to any of claims 1 to 3, wherein video end-system is in communication with a cloud service, and the application environment is provided on the cloud service.

9. The computer implemented method according to any preceding claim wherein
the control signals comprise signals for selectively enabling and disabling the routing of the media signals between the third-party application and the video conferencing hardware and/or the content stream of the video conferencing call.

10. The computer implemented method according to any preceding claim wherein:
the application environment is configured to transform the control signals from the control interface device having a first format to application control signals for controlling the third-party application having a second format.

11. The computer implemented method according to claim 10 wherein:
the control interface device comprises a keyboard for sending control signals which are keyboard events, and
the application environment is configured to transform the keyboard events into application control signals for controlling the third-party application.

12. The computer implemented method according to claims 10 or 11 wherein:
the control interface device comprises a touch screen having a first size for sending control signals, and
the third-party application is configured to receive application control signals from a touch screen having a second size; wherein
the application environment is configured to scale the control signals from the control interface device to the application control signals for controlling the third-party application.

13. The computer implemented method according to any preceding claim wherein:
the application environment is configured to transform the media signals from the third-party application having a first format to media signals for the content stream of the video conferencing call and/or the video conferencing hardware having a second format.

14. The computer implemented method according to any preceding claim
wherein the application environment is formed from an application programming interface (API) provided by the third-party application.

15. The computer implemented method according to any preceding claim wherein the application environment comprises customised instructions corresponding to the third-party application.

16. The computer implemented method according of claim 15 wherein the customised instructions are stored in a centralised configuration service, and the method comprises retrieving the customised instructions from the centralised configuration service.

17. The computer implemented method according to any preceding claim wherein the video end-system is in communication with a centralised monitoring service, and the method comprises: monitoring the third-party application from the centralised monitoring service.

18. The computer implemented method according to any preceding claim wherein the video end-system comprises a management interface for enabling administrators to enable or disable authorisation for the download of third-party applications.

19. The computer implemented method according to any preceding claim wherein the application environment containing the third-party application is sandboxed whereby the access by the third-party application to computer resources is restricted.

20. A computer implemented method of installing a third-party application for use by a video end-system, the video end-system for video conferencing, the method comprising:
creating an application environment;
the application environment being configured to:
route control signals from a control interface device to the third-party application, and
route media signals between the third-party application and the video conferencing hardware and/or a content stream of a video conferencing call; and
installing the third-party application inside the application environment.

21. The computer implemented method of claim 20 further comprising:
downloading customised instructions corresponding to the third-party application from a centralised configuration service for forming the application environment.

22. The computer implemented method of claims 20 or 21 further comprising:
communicating with a management server or cloud service to retrieve a list of authorised applications, and
downloading the third-party application only if the third-party application is included in the list.

23. The computer implemented method of any of claims 20 to 22 further comprising:
receiving user authentication information to enable the installation of the third-party application.

24. A computer program comprising instructions which, when the computer program is executed by a computer, cause a computer to carry out the method of any one of claims 1 to 23.

25. A video end-system for video conferencing comprising:
video conferencing hardware and a control interface device;
wherein the video end-system is configured to carry out the method of any one of claims 1 to 23.
